(19) United States
(12) Patent Application Publication
(10) Pub. No.: US 2022/0106899 A1
(43) Pub. Date: Apr. 7, 2022

(54) EXHAUST GAS AFTERTREATMENT DEVICE

(71) Applicant: Vitesco Technologies GMBH, Regensburg (DE)

(72) Inventors: Rolf Brück, Bergisch Gladbach (DE); Peter Hirth, Rosrath (DE); Sven Schepers, Troisdorf (DE); David Odenthal, Bergisch Gladbach (DE)

(73) Assignee: Vitesco Technologies GMBH, Regensburg (DE)

(21) Appl. No.: 17/553,021

(22) Filed: Dec. 16, 2021

Related U.S. Application Data
(63) Continuation of application No. PCT/EP2020/067590, filed on Jun. 24, 2020.

(30) Foreign Application Priority Data
Jun. 26, 2019 (DE) 10 2019 209 303.5

(51) Int. Cl. F01N 3/28; F01N 3/035; F01N 13/00

(52) U.S. Cl. CPC F01N 3/2892; F01N 3/035; F01N 2240/20; F01N 2250/02; F01N 2470/24; F01N 13/0097

(57) ABSTRACT

A device for exhaust-gas aftertreatment, having a first, tubular flow path, having a diverting region and having a second, annular flow path. The tubular flow path is formed by an inner pipe and the annular flow path is, by an outer pipe running substantially parallel to the inner pipe, formed between the inner pipe and the outer pipe, and the diverting region is designed to divert the exhaust-gas flow from the tubular flow path into the annular flow path. The device has an annular catalytically active substrate body and an annular particle filter, wherein the substrate body and the particle filter are arranged in the annular flow path.

### CROSS-REFERENCE TO RELATED APPLICATIONS

This application claims priority to PCT Application PCT/EP2020/067590, filed Jun. 24, 2020, which claims priority to German Patent Application No. DE 10 2019 209 303.5, filed Jun. 26, 2019. The disclosures of the above applications are incorporated herein by reference.

### FIELD OF THE INVENTION

The invention relates to a device for exhaust-gas aftertreatment, having a first, tubular flow path, having a diverting region and having a second, annular flow path, wherein the tubular flow path is formed by an inner pipe and the annular flow path is, by an outer pipe running substantially parallel to the inner pipe, formed between the inner pipe and the outer pipe, and the diverting region is designed to divert the exhaust-gas flow from the tubular flow path into the annular flow path.

### BACKGROUND OF THE INVENTION

For the exhaust-gas aftertreatment of exhaust gases of internal combustion engines, use is made inter alia of catalytic converters that allow a conversion of exhaust-gas constituents into less harmful substances. Catalytic converters of different designs and different dimensions are known for this purpose.

Among others, the so-called annular catalytic converter is known, which has a tubular flow path which is followed by a flow diversion and subsequently an annular flow path, wherein the tubular flow path is surrounded by the annular flow path. A relatively long flow path for the exhaust gas can thus be realized even if only a short structural length of the catalytic converter is possible. This promotes, for example, the mixing of the exhaust gas or extends the time available for the reaction of a urea solution that has been injected into the exhaust-gas flow.

A flow distribution that is as homogeneous as possible or a concentration distribution that is as homogeneous as possible is advantageous in order to achieve the highest possible reaction rate of the pollutants on the catalytically active materials.

Annular catalytic converters can be used for example as classic 3-way catalytic converters in the exhaust-gas tract of a gasoline engine, or for example as a catalytic converter for selective catalytic reduction in the exhaust-gas tract of a diesel engine.

Furthermore, in particular in the case of gasoline engines, there is an increasing problem with ultrafine exhaust-gas particles, such that the use of additional particle filters is now being considered in the case of gasoline engines too. Such particle filters are usually arranged in the exhaust-gas tract so as to be separate from the actual catalytic converters.

In particular with regard to the ever-increasing demands on the exhaust-gas aftertreatment and the ever more restrictive structural space requirements of the manufacturers, the arrangement of all of the components required for effective exhaust-gas aftertreatment poses an ever greater challenge.

A particular disadvantage of the devices in the prior art is that optimal exhaust-gas aftertreatment cannot be ensured if a particle filter is required in addition to the catalytic converter and the available installation space, in particular the installation length, is small.

### SUMMARY OF THE INVENTION

It is therefore the object of the present invention to create a device which allows optimized exhaust-gas aftertreatment and filtering of particles entrained in the exhaust gas, and in an embodiment, the device has a short installation length.

The object relating to the device is achieved by a device having the features described herein.

One exemplary embodiment of the invention relates to a device for exhaust-gas aftertreatment, having a first, tubular flow path, having a diverting region and having a second, annular flow path, wherein the tubular flow path is formed by an inner pipe and the annular flow path is, by way of an outer pipe running substantially parallel to the inner pipe, formed between the inner pipe and the outer pipe, and the diverting region is designed to divert the exhaust-gas flow from the tubular flow path into the annular flow path, wherein the device has an annular catalytically active substrate body and an annular particle filter, wherein the substrate body and the particle filter are arranged in the annular flow path.

A device for exhaust-gas aftertreatment constructed in this way is also referred to as an annular catalytic converter. Proceeding from a flow inlet, the exhaust-gas flows through a tubular flow path in the center of the annular catalytic converter. The exhaust-gas flows from the tubular flow path into a diverting region, in which the exhaust gas is diverted, in an embodiment, through 180 degrees. This diversion takes place firstly outward in the radial direction and finally into the second annular flow path, through which flow passes in the opposite direction in relation to the tubular flow path. From the annular flow path, the exhaust gas flows out of the annular catalytic converter via a flow outlet.

The tubular flow path serves substantially for mixing the flowing exhaust gas and thus for homogenizing the exhaust-gas flow and the concentration distribution in the exhaust gas. In the diverting region, the exhaust-gas flow is diverted from the tubular flow path, which is arranged centrally in the radial direction, into the annular flow path, which is situated radially at the outside. Finally, the elements provided for exhaust-gas purification and exhaust-gas aftertreatment are arranged in the annular flow path. In an embodiment, these may be annular metallic honeycomb bodies with catalytically active coatings, or else filter elements composed of metal nonwoven or other porous structures. The annular elements may for example also be formed from multiple individual elements arranged adjacent to one another in a circumferential direction or in series in an axial direction.

In an embodiment, the cross section of the first flow path and/or the second flow path narrows or widens conically in the flow direction.

The cross section of the flow paths may remain constant along the flow direction. This is the case for example if the inner pipe and the outer pipe are arranged parallel to one another. Should the inner pipe and/or the outer pipe be of conical form along the respective axial extent, the configuration may also result in conically narrowing and/or conically widening flow paths. For example, a flow concentration is achieved by a conical narrowing, whereas an expansion of the flow is achieved by a widening. It is thus for example also possible to influence the pressure loss that occurs.

In an embodiment, the inner pipe and the outer pipe are arranged concentrically with respect to one another. This results in a flow cross section that remains constant along the circumference of the annular flow path. The flow cross section may vary along the axial direction, but remains constant in the circumferential direction owing to the concentric orientation of the two pipes with respect to one another.

In an embodiment, the particle filter is arranged downstream of the catalytically active substrate body in the flow direction. This achieves the highest possible temperature of the exhaust gas at the catalytically active substrate body and minimize the pressure loss that occurs upstream of the catalytically active substrate body.

In an embodiment, a further particle filter is arranged in the diverting region, wherein the particle filter in the diverting region is more coarsely porous than the annular particle filter in the second flow path. An additional upstream particle filter increases the overall particle separation. In addition, pre-filtering takes place upstream of the catalytically active substrate body, whereby at least the relatively large particles are filtered out of the exhaust-gas flow. As a result, the overall service life of the system is lengthened, since the risk of the substrate body becoming blocked is reduced. Furthermore, the absorption of particles in the annular filter is also reduced, which is positive for the occurring pressure loss, since this is thereby less pronounced.

In an embodiment, the annular particle filter has a cross section that widens or narrows conically in the flow direction. For this purpose, it is for example possible for the jacket that delimits the particle filter outwardly in the radial direction to be of conical form. Here, the matrix that forms the filter body may for example have a cross section that remains constant in the flow direction.

In an embodiment, the annular particle filter has a filter matrix which has a cross section that narrows or widens in the flow direction.

It is also expedient if the coarsely porous particle filter in the diverting region is formed as a coating of a wall region. The coarsely porous filter may for example be applied as a thin layer of a nonwoven to the wall region of the diverting region as a coating.

In an embodiment, the diverting region is formed by a cover-like element which is connected in gas-tight fashion to the outer pipe. The cover-like element may, in the interior, have a geometry which is adapted to the respective annular catalytic converter and which promotes the flow diversion.

It is furthermore expedient if the cover-like element forms, in the interior of the annular catalytic converter, a baffle wall for the exhaust gas, wherein the baffle wall has a coating that acts as a particle filter.

Embodiments of the present invention are described in in the following description of the FIGURES.

### BRIEF DESCRIPTION OF THE DRAWINGS

The invention will be explained in detail below on the basis of an exemplary embodiment and with reference to the drawing. In the drawing:

FIG. 1 shows a sectional view through an annular catalytic converter, wherein the tubular flow path, the diverting region, the annular flow path and the catalytic converters and particle filters arranged therein are illustrated.

### DETAILED DESCRIPTION OF THE PREFERRED EMBODIMENTS

The following description of the preferred embodiment(s) is merely exemplary in nature and is in no way intended to limit the invention, its application, or uses.

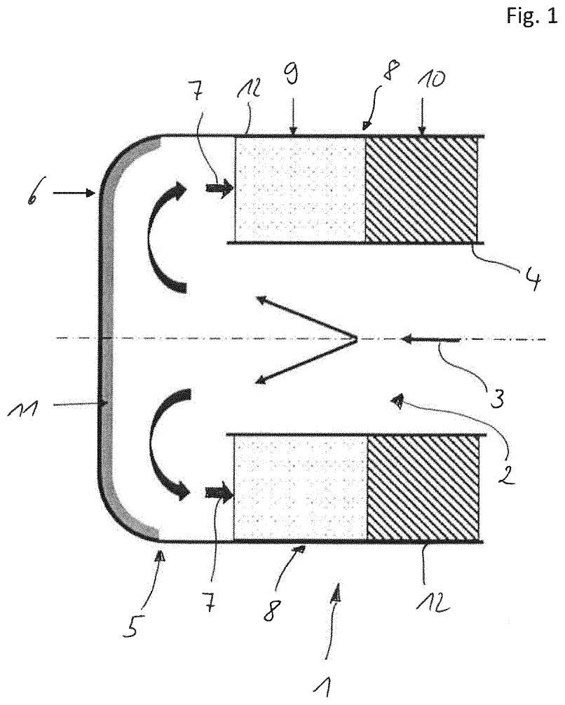

FIG. 1 shows an annular catalytic converter 1. This has a centrally situated first, tubular flow path 2 through which exhaust gas may flow along the throughflow direction 3. The tubular flow path 2 is delimited in the radial direction by an inner pipe 4. Arranged downstream of the tubular flow path 2 in the flow direction 3 is the diverting region 5.

The diverting region 5 is formed from a cover-like element 6, which is impinged on by the exhaust gas flowing through the tubular flow path 2. The impingement against the cover-like element 6 causes the exhaust gas to be diverted outward in the radial direction and finally directed in a flow direction 7 which is opposite to the throughflow direction 3 by 180 degrees.

The exhaust gas then flows through the second, annular flow path 8 through multiple elements for exhaust-gas aftertreatment arranged in this flow path 8. FIG. 1 shows an annular catalytic converter 9 which, for example, has a catalytically active coating in order to thus be able to promote the reaction of the exhaust gas. Arranged downstream of the catalytic converter 9 is a particle filter 10, which is provided for filtering the exhaust gas that has flowed through the catalytic converter 9.

The catalytic converter 9 and the particle filter 10 are each of annular construction.

The second annular flow path 8 is delimited inwardly in the radial direction by the inner pipe 4 and outwardly in the radial direction by the outer pipe 12.

In FIG. 1, the inner pipe 4 and the outer pipe 12 are arranged concentrically and parallel with respect to one another. This results in an annular gap between inner pipe 4 and outer pipe 12 that remains constant in the circumferential direction. As already described, conical pipes may also be used here and, if necessary, a non-concentric arrangement of the pipes with respect to one another may also be selected.

A filter layer 11 is arranged on the inner wall of the cover-like element 6 in the diverting region 5, which filter layer acts as a coarse filter for the particles entrained in the exhaust gas. The filter layer 11 is in this case is more coarsely porous than the particle filter 10. The aim of the filter layer 11 is to pre-filter the exhaust gas in order to subsequently prevent a blockage of the catalytic converter 9 or of the particle filter 10, which is more finely porous than the filter layer 11.

As an alternative to a type of coating of the inner wall of the cover-like element 6, a honeycomb body acting as a filter may also be introduced into the diverting region 5. The pressure loss caused by the filter layer 11, and the adverse influence on the gas flow, is very small. For the most optimum possible action of the catalytic converter and of the particle filter, it is sought to achieve as homogeneous a flow distribution as possible over the cross section of the flow paths 2, 8, and also as uniform as possible a concentration distribution of the exhaust gas.

The exemplary embodiment in FIG. 1 is not of a limiting nature, and serves for illustrating the concept of the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device for exhaust-gas aftertreatment, having
an inner pipe;
a tubular flow path formed by the inner pipe;
an outer pipe running substantially parallel to the inner pipe;
an annular flow path formed between the inner pipe and the outer pipe;
a diverting region which diverts the exhaust-gas flow from the tubular flow path into the annular flow path;
an annular catalytically active substrate body; and
an annular particle filter;
wherein the substrate body and the particle filter are arranged in the annular flow path.

2. The device of claim 1, wherein the cross section of the first flow path narrows or widens conically in the flow direction.

3. The device of claim 1, wherein the cross section of the second flow path narrows or widens conically in the flow direction.

4. The device of claim 1, wherein the inner pipe and the outer pipe are arranged concentrically with respect to one another.

5. The device of claim 1, wherein the particle filter is arranged downstream of the catalytically active substrate body in the flow direction.

6. The device of claim 1, further comprising:
a second particle filter arranged in the diverting region;
wherein the particle filter in the diverting region is more coarsely porous than the annular particle filter in the annular flow path.

7. The device of claim 6, the second particle filter in the diverting region further comprising a coating of a wall region.

8. The device of claim 7, the diverting region further comprising a cover-like element which is connected in gas-tight fashion to the outer pipe.

9. The device of claim 8, the cover-like element further comprising:
a baffle wall in the interior of the annular catalytic converter;
wherein the baffle wall has a coating that acts as a particle filter.

10. The device of claim 1, wherein the annular particle filter has a cross section that widens or narrows conically in the flow direction.

11. The device of claim 1, the annular particle filter further comprising a filter matrix which has a cross section that narrows or widens in the flow direction.
